(19) United States
(12) Patent Application Publication
(10) Pub. No.: US 2017/0343429 A1
(43) Pub. Date: Nov. 30, 2017

(54) STRESS SENSING DEVICE

(71) Applicant: HON HAI PRECISION INDUSTRY CO., LTD., New Taipei (TW)

(72) Inventor: TSUNG-JU WU, New Taipei (TW)

(21) Appl. No.: 15/246,532

(22) Filed: Aug. 25, 2016

(30) Foreign Application Priority Data
May 28, 2016 (CN) 201610360325.X

(51) Int. Cl. G01L 1/16; G01S 15/08

(52) U.S. Cl. CPC G01L 1/16; G01S 15/08

(57) ABSTRACT

A stress sensing device for a robot, a medical device, or a toy, for example, includes a substrate, a support structure, and stress sensing components. Each sensing component of the four disclosed stress sensing components comprises a first electrode, a piezoelectric material layer, and a second electrode. Each first electrode comprises a two-ended body, and a hinge structure located at each end of the body. The body is arcuate, and the configuration of the four sensing components arranged in a cross formation enables sensing in three dimensions of stress applied.

### FIELD

The present disclosure relates to a stress sensing device.

### BACKGROUND

Stress sensors are widely used for measuring stress. However, stress sensors can only sense stress along a single direction. Moreover, the stress sensor usually comprises an adhesive for bonding different components. Therefore, a damaged component cannot be easily disassembled and replaced, and the adhesive may prevent total accuracy of the sensing result.

### BRIEF DESCRIPTION OF THE DRAWINGS

Implementations of the present technology will now be described, by way of example only, with reference to the attached figures, wherein:

FIG. 1 is a diagrammatic view of an exemplary embodiment of a sensing device.

FIG. 2 is a top diagrammatic view of the sensing device of FIG. 1.

FIG. 3 is a bottom diagrammatic view of the sensing device of FIG. 1.

FIG. 4 is a diagrammatic view of a first electrode of the sensing device of FIG. 1 when being unfolded.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

One definition that applies throughout this disclosure will now be presented.

The term “comprising,” when utilized, means “including, but not necessarily limited to”; it specifically indicates open-ended inclusion or membership in the so-described combination, assembly, series and the like.

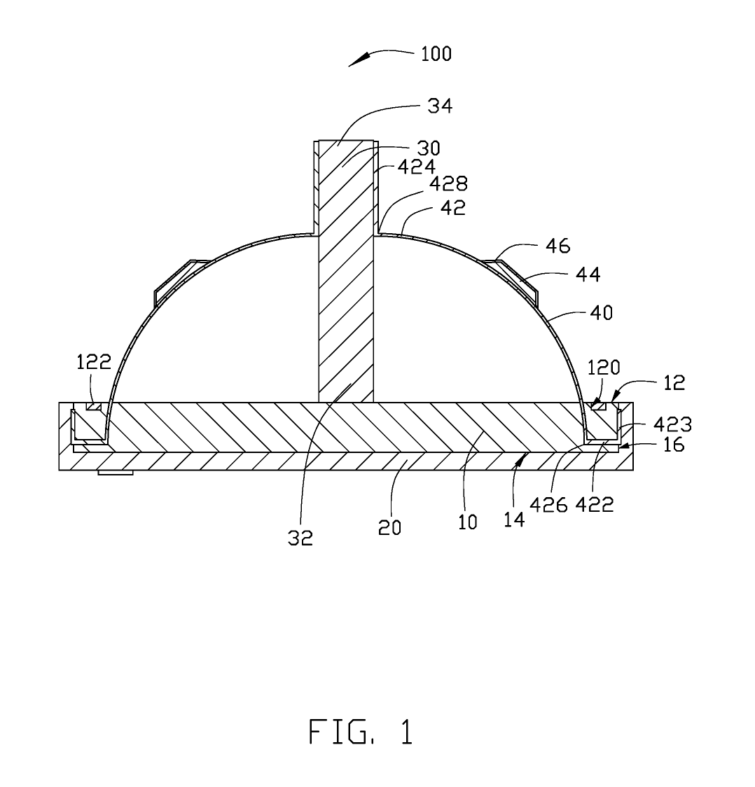

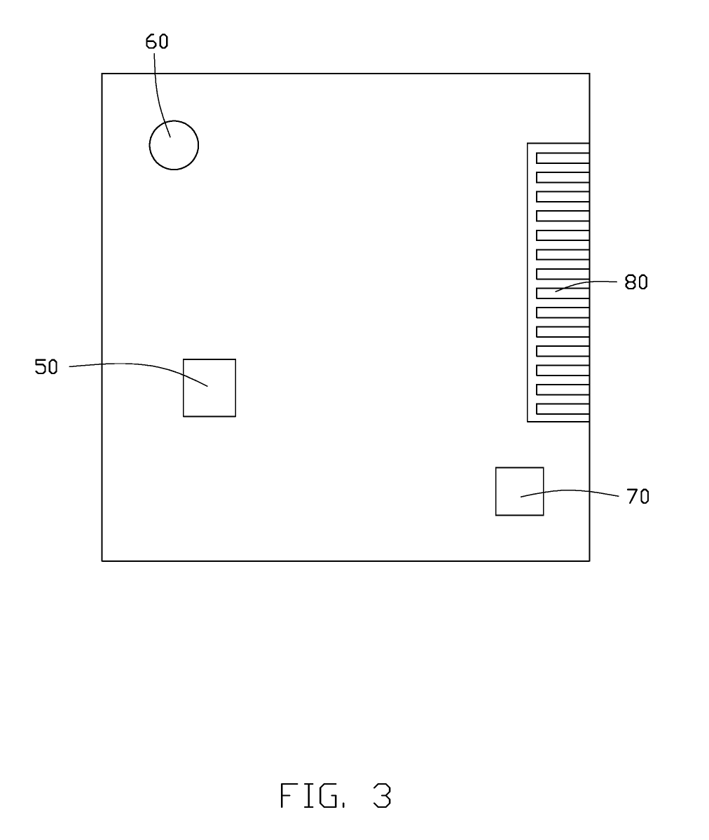

FIGS. 1 to 4 illustrate a stress sensing device 100. The stress sensing device 100 comprises a substrate 10, a circuit board 20, a support structure 30, a stress sensing assembly 40, a first signal processing device 50, an ultrasonic generator 60, and a second signal processing device 70.

The substrate 10 is configured to support the circuit board 20, the support structure 30, and the stress sensing assembly 40. The substrate 10 comprises an upper surface 12, a lower surface 14, and side surfaces 16. The upper surface 12 and the lower surface 14 are located at opposite sides of the substrate 10. The side surfaces 16 are positioned between and connected to the upper surface 12 and the lower surface 14. An annular groove 120 is defined at the upper surface 12. The annular groove 120 is configured to receive a signal transmitting line 122 which electrically connects the ultrasonic generator 60 to the signal processing device 70.

The circuit board 20 is connected to the lower surface 14 and wraps around the side surfaces 16.

The support structure 30 is mounted on the substrate 10. The support structure 30 provides support for the stress sensing assembly 40 on the substrate 10. The support structure 30 is substantially cylindrical. The support structure 30 comprises a bottom end 32 and a touch end 34. The bottom end 32 is opposite to the touch end 34. The bottom end 32 is mounted on the upper surface 12. The support structure 30 is made of elastic material such as rubber or silicone. The touch end 34 senses an external pressing force.

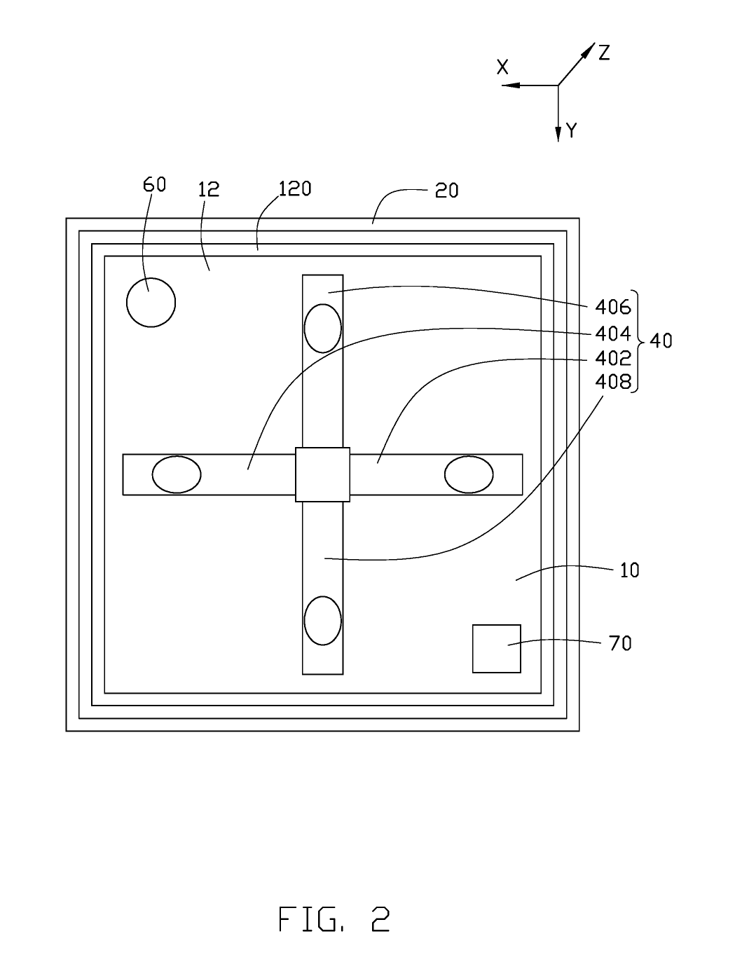

The stress sensing assembly 40 comprises a plurality of stress sensing components, 402, 404, 406, and 408. FIG. 2 illustrates the stress sensing assemblies 40 and these components. The four stress sensing components 402, 404, 406, and 408 cooperate to measure stresses along the X-axis, the Y-axis, and the Z-axis directions. That is, the stress sensing assembly 40 is capable of measuring stress in three-dimensions.

Shapes and sizes of the four stress sensing components 402, 404, 406, and 408 are the same. Each of the stress sensing components 402, 404, 406, and 408 is arcuate. One end of each of component 402, 404, 406, and 408 is connected to the substrate 10, and the other end is connected to the support structure 30.

Projections of each component 402, 404, 406, and 408 on the substrate 10 are perpendicular to each other. Each of the two opposite components of the components 402, 404, 406, and 408 on the substrate 10 are located along an imaginary straight line.

In at least one exemplary embodiment, the components 402 and 404 are opposite to each other and are positioned along a first substantially straight line. The stress sensing components 402 and 404 measure stresses along the X-axis and Z-axis directions based on deformation from a pressing force. A deformation amount can be separated into two sub-amounts; one sub-amount along the X-axis direction used to calculate the stress along X-axis direction, and one sub-amount along the Z-axis direction used to calculate the stress along Z-axis direction.

The stress sensing components 406 and 408 are also opposite to each other and are located along a second substantially straight line which is perpendicular to the first substantially straight line. The stress sensing components 406 and 408 are configured to measure stresses along the Y-axis and Z-axis directions based on deformation from a pressing force, and function in the same way as components 402 and 404.

Each component 402, 404, 406, and 408 includes a first electrode 42, a piezoelectric material layer 44, and a second electrode 46. The piezoelectric material layer 44 is deposited on the first electrode 42, and the second electrode 46 is deposited on the piezoelectric material layer 44. Both the first electrode 42 and the second electrode 46 are electrically connected to the piezoelectric material layer 44. In the exemplary embodiment, the piezoelectric material layer 44 and the second electrode 46 are located at the center of the first electrode 42.

The first electrode 42 is made of metal, for example, stainless steel.

The piezoelectric material layer 44 is made of a piezoelectric material. The piezoelectric material may be a single crystal material, a polymer material, a thin film material, a ceramic material, or composite materials, such as PbZrTiO3, BaTiO3, ZnO, PVDF, or quartz. In other exemplary embodiments, different piezoelectrical materials may be used.

The second electrode 46 is made of metal.

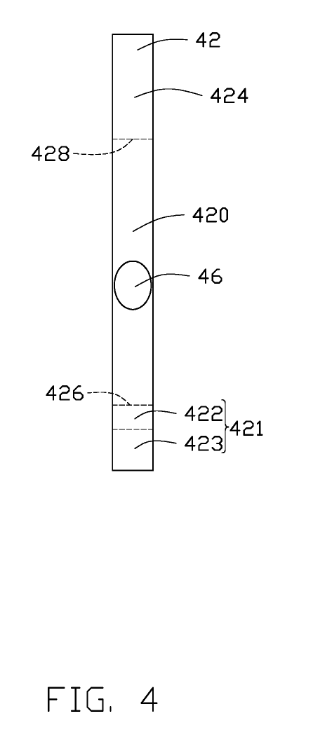

FIG. 1 and FIG. 4 illustrate the first electrode 42 includes a body 420, a first end 421, a second end 424, a first hinge structure 426, and a second hinge structure 428. The body 420 is curved to avoid material fatigue caused by stress concentration. The first end 421 and the second end 424 are located at opposite ends of the body 420. The first hinge structure 426 is located at a junction between the first end 421 and the body 420. The second hinge structure 428 is located at a junction between the second end 424 and the body 420.

The first end 421 includes a first portion 422 and a second portion 423. The first portion 422 is connected to the second portion 423. The first portion 422 faces towards the second end 424 and the second portion 423 faces away from the second end 424.

Each first end 421 is fixed to the substrate 10. The first ends 421 of the components 402, 404, 406, and 408 are evenly distributed along an imaginary circle which has a center located at the bottom end 32 of the support structure 30, and a radius equal to a distance between the first hinge structure 426 and the bottom end 32. The first portion 422 is secured to the substrate 10. In the illustrated exemplary embodiment, the first portion 422 is parallel to the upper surface 12 and embedded in the substrate 10. The second portion 423 is attached to the side surfaces 16, and positioned between the substrate 10 and the circuit board 20. The second portion 423 is perpendicular to the first portion 422.

One end of the first hinge structure 426 is fixed to the first portion 422, and the other end of the first hinge structure 426 is fixed to the body 420. A pivot of the first hinge structure 426 is fixed in the substrate 10.

One end of the second hinge structure 428 is fixed to the second end 424, the other end of the second hinge structure 428 is fixed to the main body 420. The second hinge structure 428 is pivotally fixed on the support structure 30. The first hinge 426 and the second hinge 428 cooperatively mount the body 420 onto substrate 30.

The second hinge structures 428 are positioned at a same height relative to the bottom end 32. Each second end 424 is adhered to the touch end 34. Distances between centers of the piezoelectric material layers 44 and the substrate 10 are substantially equal to each other.

The first signal processing device 50 is arranged on the circuit board 20 and is electrically connected to the components 402, 404, 406, and 408. The first signal processing device 50 stores masses of relational data for determining amounts of deformation, voltage values, and stress values. Each amount of deformation corresponds to one voltage value and one stress value. The first signal processing device 50 receives voltage from the stress sensing assembly 40, calculates the stress value according to the stored relational data, and produces a first signal accordingly.

The ultrasonic generator 60 and the first signal processing device 50 are embedded in the substrate 10. The ultrasonic generator 60 emits ultrasonic signals. The ultrasonic signals are reflected by an object (not shown) and received by the second signal processing device 70. The second signal processing device 70 calculates the distance between the object and the stress sensing device 100, and produces a second signal according to the calculated distance.

A connection port 80 is electrically connected to the first signal processing device 50 and the second signal processing device 70. The connection port 80 receives the first signal from the first processing device 50 and the second signal from the processing device 70.

When in use, the ultrasonic generator 60 senses the instant distance between the stress sensing device 100 and the object. The ultrasonic generator 60 emits an ultrasonic signal. When the touch end 34 is touched by a body part (for example a fingertip) of the user, the ultrasonic signal is reflected from the fingertip and received by the second signal processing device 70. The second signal processing device 70 then calculates the distance between the stress sensing device 100 and the object based on the reflected ultrasonic signal, and then outputs the second signal.

The ultrasonic generator 60 stops emitting the ultrasonic signal when the touch end 34 is touched. Each or some of the stress sensing components 402, 404, 406, 408 is deformed due to the external force and generate a voltage accordingly. The first signal processing device 50 receives the voltage from the stress sensing assembly 40 and generates a first signal according to the voltage. The first signal is received by the connection port 80.

The stress sensing device 100 may be implemented in a robot, a medical device, or a toy, (none of which are shown) for sensing the distance between the user and the stress sensing device 100, and sensing the force applied by a user or object.

With the above configuration, the stress sensing device 100 can measure stresses along three-dimensions. Furthermore, the first hinge structure 426 and the second hinge structure 428 can replace the adhesive generally used for affixing different components, thereby improving an accuracy of the sensing.

The exemplary embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including, the full extent established by the broad general meaning of the terms used in the claims.

What is claimed is:

1. A stress sensing device comprising:
a substrate;
a support structure comprising a bottom end and a touch end opposite to the bottom end, the bottom end mounted on the substrate;
a stress sensing assembly comprising at least two stress sensing components supported on the substrate by the support structure, each sensing component comprising a first electrode, a piezoelectric material layer positioned on the first electrode, and a second electrode positioned on the piezoelectric material, the first electrode and the second electrode are electrically connected to the piezoelectric material layer, wherein each first electrode comprises a body, a first end located at one end of the body, a second end located the other, opposite end of the body, a first hinge structure located at a junction between the first end and the body, and a second hinge structure located at a junction between the second end and the body, each first end is fixed to the substrate by the first hinge structure, each second end is fixed to the touch end by the second hinge structure, the body is arcuate.

2. The stress sensing device of claim 1, wherein the first ends are evenly distributed along an imaginary circle which has a center located at the bottom end, and a radius equaling to a distance between the first hinge structure and the bottom end.

3. The stress sensing device of claim 1, wherein the second hinge structures are positioned at a same height relative to the bottom end, and the distances between centers of the piezoelectric material layers and the substrate are equal to each other.

4. The stress sensing device of claim 1, wherein the stress sensing assembly comprises four stress components, wherein each of the four stress sensing components comprise of projections on the substrate are perpendicular to each other, and wherein the projections of two opposite stress sensing components on the substrate are located along an imaginary straight line.

5. The stress sensing device of claim 1, wherein the stress sensing device further comprises a circuit board, the circuit board is on a lower surface of the substrate, the substrate comprises side surfaces, the side surfaces of the substrate are covered by the circuit board, the circuit board is electrically connected to each of the stress sensing components.

6. The stress sensing device of claim 5, wherein each first end comprises a first portion and a second portion, the first portion facing towards the second end, the second portion facing away from the second end.

7. The stress sensing device of claim 6, wherein the first portion is fixed to the substrate, and the second portion is attached to the side surfaces and positioned between the substrate and the circuit board.

8. The stress sensing device of claim 1, wherein the stress sensing device further comprises a first signal processing device, wherein the first signal processing device is arranged on the circuit board, electrically connected to the at least two stress sensing components, and configured to receive a voltage from the at least two stress sensing components to calculate the stress value according to a voltage value of the received voltage and produce a first output signal.

9. The stress sensing device of claim 1, wherein the stress sensing device further comprises an ultrasonic generator and a second signal processing device, the ultrasonic generator and the second signal processing device are embedded in the substrate, the ultrasonic generator is configured to emit ultrasonic signals, and the second signal processing device receives the ultrasonic signals from the ultrasonic to calculate a distance between the obstacle and the stress sensing device and produce a second output signal according to the calculated distance, and the ultrasonic generator stops emitting ultrasonic signals when the ultrasonic generator receives the second output signal.

10. The stress sensing device of claim 5, wherein the stress sensing device further comprises a connection port located at the lower surface of the substrate.

11. The stress sensing device of claim 10, wherein the connection port is electrically connected to the first signal processing device and the second signal processing device, and configured to receive the first output signal from the first signal processing device, and the second output signal from the second signal processing device.

12. The stress sensing device of claim 1, wherein the first electrode material is stainless steel.
